(19) United States
(12) Patent Application Publication
(10) Pub. No.: US 2003/0154116 A1
(43) Pub. Date: Aug. 14, 2003

(54) System and method for scheduling events on an internet based calendar

(76) Inventor: Jeffrey C. Lofton, North Wales, PA (US)

Correspondence Address: HARDING, EARLEY, FOLLMER & FRAILEY, 86 THE COMMONS AT VALLEY FORGE EAST, 1288 VALLEY FORGE ROAD, VALLEY FORGE, PA, 19482, US

(21) Appl. No.: 10/037,912

(22) Filed: Jan. 4, 2002

(51) Int. Cl. G06F 17/60

(52) U.S. Cl. 705/8

(57) ABSTRACT

A system and method for scheduling providing an Internet-based calendar for use by a number of people, where each user has a personal calendar which is associated with the user through user identification data to permit users to automatically receive updates of events which have been posted by one or more other users to appear on the receiving user's calendar, with each user being able to post events on the user's own calendar and delete events on the user's own calendar whether or not the event to be deleted has been posted by another user or the deleting user.

### BACKGROUND OF THE INVENTION

1. Field of the Invention

The field of the invention relates to calendars for scheduling events, and in particular, to an Internet-based calendar system and method for notifying users of their own scheduled events and events scheduled by others which are pertinent to them.

2. Brief Description of the Related Art

Many different calendars are known and used to record events as a way to remind the calendar owner or user of the future event. One of the most basic types of calendars is the appointment book calendar, which for the most part consists of paper pages numbered and lined for each day, and usually listing the times of the day. Some of these calendars are provided in the form of a small, pocket-sized book for ease of transportability, others are provided for desktop use.

In the evolution of the electronic age, where electronic communications and electronic storage media are now prevalent, the use of electronic calendars is often employed. These electronic calendars represent another type of commonly used calendar. For example, some of the electronic calendars take the form of personal organizers, or wallet size, electronic storage devices. There are even small personal computing devices which may include a calendar or scheduling program.

Another example of calendars can be found in software programs for personal computers, which have calendar and scheduling capability. A user can input events into the calendar and even set reminders or alerts which are generated to appear on a computer screen display.

With the availability of information almost instantaneously, or in a short duration of time, contrasted with years ago, the time of individuals becomes even more valuable. Scheduling an individual's time can often become a task in itself. This is even complicated further when there are more individuals involved. Take for example, the family, where one or more parents are responsible for getting their children to various places and activities on time. This has proven a difficult task, even with the use of today's calendars.

There have, however, been attempts to provide scheduling or calendar systems. One such example of a calendar system is the use of posted events where users interested in a particular activity can access the posted events. These posted events may appear on an electronic bulletin board. The bulletin board type of calendar, while useful provided the user checks it, is static, and therefore, if an event changes, or is canceled, the user who viewed the bulletin board prior to the change remains unaware of the change. These types of calendars are generally freely available to the public, and can be accessed by anyone, even members who have no interest in the activities of the posted group or organization, or whose interests are adverse to the posting group. The bulletin board type calendars also suffer from additional drawbacks. If a user is a member of more than one group or organization, and each of those groups has a separate posted bulletin board calendar, the user must access both, and then somehow note the events.

In many cases, corporate meetings are to be scheduled, and companies have used integrated software to determine availability of other users. One such example is a program of the Microsoft Corporation, entitled Outlook®. Outlook® has the ability to provide a calendar, and have each user employ his or her Outlook® program to schedule events with other users at a time which does not conflict with any other events of the users. There are yet other programs, such as Microsoft Scheduler®, and Groupwise by Novell, Inc. which require that each user of the system have a separate software installation on his or her personal computer.

Another example of a calendar system is disclosed in U.S. Pat. No. 5,960,406 entitled “Scheduling System for Use Between Users on the Web” issued on Sep. 28, 1999 to Rasansky, et al. The '406 patent provides a scheduling system for people to make appointments, arrange meetings, and create other sorts of events that occur at an agreed upon moment in time, where the time is adjusted for different time zones between end users of the system.

U.S. Pat. No. 6,167,379 issued on Dec. 26, 2000 to Matthew T. Dean, et al. discloses a “System for User to Accept or Decline Updating a Calendar Remotely with a Proposed Schedule Update that May Have Schedule Confliction”. The '379 patent provides a system which allows a user to accept an update to a calendar which will then override a previously entered update, and thereafter an acceptance or rejection message is transmitted to a second calendar. Likewise, U.S. Pat. No. 5,774,867 issued on Jun. 30, 1998 to Gregory P. Fitzpatrick, et al. discloses a “Meeting Conflict Resolution for Electronic Calendars.”

With prior calendars, individual software was generally required for each user. Prior calendars, web or Internet type calendars, have employed overlays, which are superimposed over a calendar. With the overlay type of calendar, for example, if an overlay contained more than one event, and the user desired to remove only one event, the user could not do so without removing the overlay, and thus other events which the user wanted to remain on the calendar. Conversely, if the user were able to delete the overlay, the overlay would not be available to overlay on other user's calendars.

The prior art systems, for the most part, direct their focus and attention to the needs of corporations and group scheduling, where users are attempting to schedule an event at a time and date which avoids conflicts with other users.

A need still exists for a calendar system which is easy to implement and use, requires minimal hardware and software to operate, and can handle the needs of families including parents, children, their friends and associates, as well as handle the personal events of a user including a user's private events, and events of organizations and groups.

### SUMMARY OF THE INVENTION

A system and method for scheduling events, providing an Internet-based calendar for use by a number of people to schedule events and reminders, where each user has a personal calendar which is associated with the user through user identification data, such as, for example, a user's e-mail address, is provided. The system and method permit users to automatically receive updates of events which appear on the user's calendar. The user, in addition to events posted by other users which appear on the user's calendar, may add the user's own events, and can even delete events from the user's calendar.

The system features a data storage mechanism for storing data. Examples of types of data stored by the system can include general calendar data such as months, days and times and the sequences of their occurrence over time periods, data about the user which may include identification data and password information data (user data), data about events (event data), data concerning groups of users, and data about linked information (link data). The data storage mechanism preferably utilizes a computer, such as a server on which the various data is stored and can be accessed by a viewing device. For example, a user preferably uses a personal computer which has an input device for entering data and retrieving the calendar of the user through a selection of displaying options.

A processing device, such as, for example, a microprocessor, is employed to carry out the functions of associating the event data with user data, and link data with event data, as well as associating a user with one or more groups, or associating user aliases so that a plurality of aliased e-mail addresses may identify a single user. The system preferably stores data on a server, and users utilize a personal computer which communicates with the server through the Internet.

The system and method preferably has an alias mechanism to facilitate the ability of a user to be recognized as a single user of the system even though the user may have different user identification data (for example, different e-mail addresses). That is, taking for example, the case where a user has one e-mail address identifying the user, which the user uses with his or her place of employment, and a personal e-mail address which the user uses with non-work related matters, such as organizations, sports teams, clubs, etc. of which the user may be a member. In the event that the user's employer identifies the user with the work e-mail address and others identify the user with the user's personal e-mail address, the system identifies the user as a single user, and a single calendar may show the posted events for that user, regardless of which e-mail address of the user was designated by an event-posting user.

The system and method of the present invention provide a user with a capability to access the home page of the system by linking through the user's own computer to the system server address. The user logs onto the system by entering identification data at the welcome or home screen, or at a prompt on the home page which brings the user to an identification screen. Upon logging onto the system, the user may select, as an option, to have the user's calendar displayed with events placed onto the system by other users, including events which were on the user's calendar when last viewed (unless previously deleted or changed), and events placed on the system for the user by another user.

Once the user's calendar is accessed, the user can choose to leave an event on his calendar or can delete an event. The user can delete an event placed on his calendar by that user or another user. The deletion of a group event from the user's calendar does not affect the viewability of the group event on another user's calendar.

The invention further provides for the control of a user's calendar by permitting a user to not only delete events from the user's calendar, but also to redisplay these events at a later time, as needed.

The system and method of the present invention also permit a user to selectively allow one or more other users to view the permitting user's calendar. In addition, the user may simply choose to permit one or more other users to view only the availability of the user's time, without viewing the events taking up a particular time or date position. This provides a security mechanism for the permitting user. Furthermore, it is possible for a user to designate an event a private event on the system. That is, when the user posts a private event on that user's personal calendar, the private event is not viewable by anyone other than that posting user.

The system and method further may include a linking mechanism for linking event data with another document, including, for example, a document, such as, for example, a web page containing text, photographic, or other material which is contained in link data stored on the system data storage device. An event may appear on the user's personal calendar and with it, a link identifying that there is further information available for the event. This could be, for example, a brochure which served as the basis for originating the placing of the event on the system for users to view, directions or other material. A user may supply the link data from the user's own outside data, which, prior to initializing the user outside data as link data, may have been only available to the user outside of the system.

The system and method of the present invention has particular utility for parents in connection with maintaining a schedule of their children's activities. For example, the personal calendar of a parent may list all of their children's activities.

Optionally, the parents may have a hierarchical level calendar which includes the parent's events as well as the events of the children. However, in accordance with an embodiment of the invention, the child can be given an access level which does not affect the parent's calendar when the child makes changes to the child's calendar. The system and method therefore can permit a parent to be kept informed, and permit the use of the calendar by both the parent and child.

### BRIEF DESCRIPTION OF THE DRAWING FIGURES

FIG. 1 is a schematic drawing of a diagram of a system and method for scheduling events on an Internet-based calendar, illustrating an example of the creation of a new schedule by a new user for that new user.

FIG. 2 is a schematic drawing of a diagram of a system and method for scheduling events on an Internet-based calendar, illustrating an example of the automatic creation of a new schedule by an existing user for a new user.

FIG. 3 is an illustration of an example of a screen display showing a starting screen, or home page, where a user may enter user information and log on to the system server.

FIG. 4 is an illustration of an example of a screen display showing a user information screen of the system of the present invention.

FIG. 5 is an illustration of an example of a screen display showing options of the system which the user may select after logging on to the system server.

FIG. 6 is an illustration of an example of a screen display showing options for posting of an event by a user on the system to the calendars of that user or other users.

FIG. 7 is an illustration of an example of a screen display showing the confirmation of e-mail addresses with the user testing means.

FIG. 8 is an illustration of an example of a screen display identifying shared access to a user's calendar.

FIG. 9 is an illustration of an example of a screen display showing the use of alias names for multiple e-mail address recognition for a single user.

FIG. 10 is an illustration of an example of a screen display of a calendar schedule view for a user of the system.

FIG. 11 is an example of a screen display showing link data provided as a link from the entry “directions” appearing on the calendar shown in FIG. 10.

FIG. 12 is an illustration of an example of a screen display showing viewing options for a user's calendar.

FIG. 13 is another illustration of an example of a screen display showing viewing options for a user's calendar, wherein a start date for the calendar display may be specified.

FIG. 14 is an illustration of an example of a screen display showing options for distribution list management.

FIG. 15 is an illustration of an example of a screen display showing options for changing a user's password.

FIG. 16 is an illustration of an example of a screen display showing options for managing link data which a user may select to be referenced by an event posted by that user.

FIG. 17 is an illustration of an example of a screen display showing options for posting of an event by a user on the system to the calendar of that user.

### DETAILED DESCRIPTION OF THE PREFERRED EMBODIMENTS

Reference now being made to the drawing figures, a preferred embodiment of the present system and method for scheduling events on an Internet based calendar is illustrated. The system comprises a data storage means for storing a data which is maintained and processed to carry out the notification and scheduling of events and the calendars of the system users. The data storage means may comprise any suitable device for storing data so the data can be available for access and retrieval. For example, in accordance with a preferred embodiment of the present invention, the data storage means comprises a magnetic storage media, such as, for example, a computer hard disk drive. The disk drive may be contained in, or provided with or to be used in conjunction with, a computer, such as a server which has a microprocessor.

It is particularly preferred that a user device is employed to facilitate the user's access to the system through a communications link to the system server. Preferably, the communications link can comprise an Internet connection which links the user device with the system server. The user device preferably can comprise a personal computer. A microprocessor of the user's personal computer can process the system data, such as for example, user data and event data. The user device preferably comprises input means and viewing means.

Input means for inputting data into the data storage means of the system and for retrieving data stored in the system from the data storage means, including users' calendars, is provided. In a preferred embodiment of the present invention, the input means may comprise a keyboard. The input means can comprise a computer mouse alternately or in addition to the keyboard. Although not shown, the input means can alternately or additionally comprise a voice recognition device, such as for example, voice recognition software and a microphone, such as those commercially available which operate in conjunction with a personal computer. Furthermore, suitable input means, other than those specifically identified, which are capable of permitting the user to input data into the system can be employed in accordance with the present invention.

Viewing means is provided to permit the user to view the user's calendar, along with other data and information presented to the user and/or input into the system by the user. Viewing means is provided in accordance with the present invention comprising a display screen, such as a computer monitor, CRT, liquid crystal display (LCD) or the other suitable viewer. Viewing devices other than those mentioned specifically herein can be utilized to display information in accordance with the system and method of the invention.

It will be understood that both the server and user device preferably comprise viewing means and input means.

Processing means for processing the information which is input to, retrieved from and/or stored in the data storage means is provided. In accordance with a preferred embodiment of the present invention, the processing means preferably comprises a microprocessor. The server device can contain the system hard drive and the system microprocessor, and the data can be input with a keyboard and, optionally a mouse, connected to the server device, and retrieved for viewing on the viewing means, such as for example a monitor which is also connected to the server device. Alternately, each user preferably has a user device comprising a computer with a central processing unit, input means and view means which is configured for communication with the server. Preferably, an Internet connection provides the linkage for communication between a user's computer and a server which contains the system data.

Data is stored on the system data storage means. Event data contains information about an event. Event data, for example, can comprise information such as, an event description, a date (including month, day and year), event time which preferably can include a start time and an end time for the event. Other event data can comprise reminder lead time data, which can be set by the user posting the event to be a time interval, such as, for example, a number of days, prior to the event start time that a reminder should be issued to a user who is a recipient of the event. Event data may also include information which facilitates the notification of the event's description to a user.

Event designation data may be provided as a subset of event data. The system comprises, for example, all-day event designation data which identifies a property of the event. Event designation data may comprise event data which can be activated by the user posting the event to indicate that the event is to last a full day, or has no specific start time, such as a birthday.

The system further has self-posting means for permitting the user posting the event to elect to receive the event on the posting user's calendar. The self-posting means provides the user with the ability to post the event to the user's calendar, whether or not the user is posting to calendar's of other users. Preferably, in accordance with a first preferred embodiment, the self-posting means may comprise an indicator which is set with the event data which the user posting the event turns on or off, respectively, to receive the event or to prevent the event which the user is posting from appearing on that posting user's calendar. Likewise, the user may post an event to the calendars of one or more other users without posting the event to the user's calendar. This feature permits a user to notify others of events where the posting user does not need to be notified of the event. In accordance with a second preferred embodiment, the self-posting means may comprise notification means for notifying a user of an event which the user posts to only appear to his or her own calendar.

Recurring interval means for identifying a recurring event which is posted to a user's calendar every predetermined period of time is provided. The recurring event data can comprise a period identifier for recurring events. For example, a birthday, which occurs on the same day of each year, can be identified as such by a recurring field. The recurring field may also comprise a counter field which, for example, may be filled with the age of a person, a period field which indicates the frequency of the event over a certain time interval, such as once a year (i.e., annually for birthdays and anniversaries). The recurring interval means utilizes the recurring field event data to provide an event for a user's calendar at each time interval, such as the birth date, as well as indicating the age of the birthday person.

Event notification means is provided for notifying a user who is an intended recipient of a posted event. The posting user can elect whether the posted event should be noticed to intended users. The notification means may comprise a mechanism for sending electronic messages to users. For example, a user of the system can supply one or more of the intended recipient e-mail addresses to which the notice of the event can be sent. All intended user recipients of an event who provide one or more e-mail addresses for association with their user data information can be notified. The event posting user can choose to send a general message to other users that there is a new event posted, or can send a message identifying the new event posted. For example, the system may be configured so that the posting of a new event or reference to a new event can include the deletion or changing of a previously posted event, since each would be a new event even if no event is added. While e-mail is described in accordance with a preferred embodiment of the event notification means, it will be understood that the event notification means can comprise, alternately or in addition to e-mail notification, other means of notifying users, such as a telephone message (which can be prerecorded with the update or which can simply tell the user recipient that there is an update for the user's calendar). For example, the event notification means may be coordinated to communicate immediate notification via e-mail, or telephone messaging, to the intended user recipient as soon as the event is posted, or for example, can be set to issue the notification at a particular time interval, such as hourly, daily, etc., or both.

Association means for associating a user with one or more groups, or other users, such as in the case of parents and their children, may be optionally provided. The association means preferably comprises user identification data for identifying the user. The association means preferably comprises an e-mail address of the user associating that e-mail address with that user. Other users of the system who know the e-mail address of another user of the system can post an event for that user, even if the user is not yet a user of the system. The association means associates the user data of the intended user recipient, such as, for example, the intended user's e-mail address, which has been entered into the system by the event-posting user.

In accordance with a preferred embodiment of the present invention, the user data is stored in the data storage means. The user data preferably comprises, in addition to user identifying information, user security means. The user security means preferably comprises a password, which the user utilizes to log onto the system in order for the user to access the user's personal calendar. This also safeguards the user's personal calendar from others, including other users of the system who know the e-mail address of another user. The user data is stored on the data storage means. In accordance with the preferred embodiment of the present invention, the data storage means comprises magnetic media storage means, illustrated as a computer or server hard disk drive.

Event data is entered by a system user and is stored in one or more files and or sub-files on the system data storage means, such as the hard disk drive. An event record is created as a subset of event data when an event is placed on the system. The event data comprises the event record. Each event record preferably comprises one or more of event data. The event record is associated with one or more users of the system, who are the intended users of the posted event. The association is made by the processing means comparing the identification data of each intended user designated as a recipient by the event-posting user.

In accordance with a preferred embodiment of the present invention, when a match of user identification data is made during a processing step, the event record is copied into a user sub-file which is associated with the intended matched user. The user sub-file contains event data comprising event records of events which are to appear on that user's calendar. The user sub-file is preferably stored on the system hard drive. In accordance with an alternate embodiment of the present invention, event data records are stored in a global event record on the data storage means. Each intended user of the global event record has in his user sub-file a pointer that points to the global event record. Therefore, in accordance with this embodiment, each intended user of the global event record has a pointer in the user's data. When the pointer is present, it associates the global event record with the user's event data, so that the event appears on the user's personal calendar. Likewise, when the pointer is absent from the user's event data, the global event does not appear on the user's personal calendar. The user can control whether to delete the event. For example, the viewing means may display indicia, such as, for example, a check box, which the user can select by marking with the input means to turn off the pointer function for that event. The check box may be associated with user event file records as well so that when the user marks the check box, the event file record stored in the user sub-file is deleted, or, if not deleted, is hidden. When the user views the user's calendar, the hidden or deleted event no longer appears thereon. However, the event is available for other users, such as those users who have not yet seen the event, or users who have seen the event and have chosen not to delete it.

Referring to Table 1, there is shown an example of user data which is collected and stored on the system server in a user data file accessed by all users, where the user can only access the one record (or entry) matching the user's user information, such as, for example, the user's member number. Among the information represented by the user data shown in Table 1 include the user's name, address, password and other information about the user. The user password preferably is encrypted for security purposes in order to minimize unauthorized access by another. Preferably, the user data is stored on the system server in a user data subfile corresponding to that user.

TABLE 1
Field Definitions For The Membership Table

| Field Name | Type | Length | Description |
|---|---|---|---|
| member_number | Integer | 4 | The unique member number. |
| last_name | Character | 25 | The member's last name. |
| first_name | Character | 15 | The member's first name. |
| Initial | Character | 1 | The member's initial. |
| Title | Character | 3 | The member's title. |
| address1 | Character | 30 | The member's primary |
| | | | address. |
| address2 | Character | 30 | The member's secondary |
| | | | address. |
| City | Character | 20 | The member's city. |
| State | Character | 15 | The member's state. |
| zip_code | Character | 10 | The member's zip code. |
| Country | Character | 15 | The member's country. |
| Phone | Character | 25 | The member's phone |
| | | | number. |
| Password | Real | 8 | The member's encrypted |
| | | | password. |
| Password_salt | Integer | 2 | Used to help the encryption. |
| Flags | Integer | 4 | Option flags (see below). |
| bad_passwords | Integer | 1 | Bad attempts at logging in. |
| amount_owed | Integer | 1 | How much needed to register. |
| Weeks | Integer | 1 | Default weeks to display. |
| children_count | Integer | 1 | Count of children calendars. |
| trial_period_start | Date | | First time person signed up. |
| trial_period_end | Date | | Date the trial period expires. |
| last_update | Date | | Last update to schedule. |
| trial_initiated_by | Integer | 4 | The member number who sent |
| | | | the first event or 0 if created |
| | | | by the person. |
| Organization | Integer | 4 | Up to three groups the person |
| | | | is linked to. |
| last_registration | Date | | Last time payment was made. |
| Registration_end | Date | | End date for current registra- |
| | | | tion. |
| last_accessed | Date | | Last time person logged in. |
| parent_account | Integer | 4 | Which account “owns” this |
| | | | one. |
| Children | Integer | 4 | Up to four children accounts. |
| Secret | Character | 20 | Helps identify a member. |

Further user data is represented by Table 2, which illustrates user information characteristics, including those which the system associates with the user, and those which the user selects. For example, the user may select to have the calendar showing the user's schedule appear in color. The user information, including, for example, whether the user has selected the user's schedule to appear in color, preferably is selected by the user as an option, and is stored by the system so that the each user's calendar may be displayed with the user's selected preferences.

TABLE 2
Flags within the Membership Table

| Flag Name | Position | Description |
|---|---|---|
| mt_trial_period | 0 | Person still in trial period? |
| mt_active | 1 | Is the account still active? |
| mt_weekly_email | 2 | Should the calendar be emailed? |
| mt_resource | 3 | A resource instead of a person? |
| mt_locked | 4 | Was the user locked out? |
| mt_use_color | 5 | Show schedule in color? |
| mt_logged_in | 6 | Is the person logged on? |
| mt_no_timelimit | 7 | Don't check session timeout? |
| mt_show_empty | 8 | Show dates with no events? |
| mt_show_sender | 9 | Show senders address? |
| mt_european_date | 10 | Use “dd/mm/yyyy” format? |
| mt_dist_list | 11 | Can member use dist. List? |
| mt_readall | 12 | Able to read any schedule? |
| mt_show_deleted | 13 | Show events marked as deleted? |
| mt_enable_delete | 14 | Show delete box in view of schedule? |
| mt_disable_reminder | 15 | Disable reminder e-mails? |

Referring to Tables 3, 4, 5, and 6, event data is illustrated. Table 3 illustrates the event data which may be entered into and stored on the system server to describe information relating to an event.

TABLE 3
Field Definitions For An Event

| Filed Name | Type | Length | Description |
|---|---|---|---|
| Duration | Integer | 2 | In minutes. |
| Flags | Integer | 2 | Option flags (see below). |
| Repeat_interval | Integer | 1 | Not currently used. |
| Scheduler | Integer | 4 | Member number of the |
| | | | scheduler. |
| date_posted | Date | | Date/time event was posted. |
| end_repeat | Date | | Last date of repeating event. |
| web_page | Integer | 4 | Pointer to a web page. |
| Description | Character | 40 | The event's description. |

Event data which preferably includes information about an event, such as that shown in Table 2 is stored for each event to facilitate notifying one or more users by displaying event data on the calendar of each user who is an intended recipient of the event notification.

Further event data is represented by Table 4, which illustrates event characteristics which the user may select to control options for an event.

TABLE 4
Flags within the Event

| Filed Name | Position | Description |
|---|---|---|
| et_all_day | 0 | An all day event? |
| et_birthday | 1 | Should an age be calculated? |
| et_private | 2 | Don't allow anyone else to see it? |
| et_note | 3 | Is there a note attached to the event? |
| et_priority | 4 | A top-priority event? |
| et_deleted | 5 | Was the event marked for deletion? |
| et_original | 6 | First of a repeating event? |

As Table 4 illustrates, options associated with the event information may include whether the event is an all-day event; whether an age should be calculated (such as, for example, a birthday event which may be maintained to annually appear on a user's calendar); whether other users may see the event; whether there is linked data or information attached to the event; and the priority of the event.

Table 5 illustrates global event data.

TABLE 5
Field Definitions For Global Event Table

| Field Name | Type | Length | Description |
|---|---|---|---|
| Event_id | Integer | 4 | Unique identifier for each event. |
| Duration | Integer | 2 | In minutes. |
| Flags | Integer | 2 | Option flags. |
| Repeat_interval | Integer | 1 | Not currently used. |
| scheduler | Integer | 4 | Member number of the |
| | | | scheduler. |
| date_posted | Date | | Date/time event was posted. |
| end_repeat | Date | | Last date of repeating event. |
| web_page | Integer | 4 | Pointer to a web page. |
| description | Character | 40 | The events description. |

Table 5 global event data shows data similar to the event data illustrated in Table 3. However, the event data in Table 5 is global event data which further includes event identifier data so that access by more than one user can be made to the global event data.

Table 6 illustrates event data options for the event data. Preferably, the user specifies the event data information which each field represents, and the data is stored in the event data files on the system.

TABLE 6
Field Definition For The Calendar Table

| Field Name | Type | Length | Descriptlon |
|---|---|---|---|
| repeat_type | Integer | 1 | Flag used to indicate whether the |
| | | | event repeats annually, monthly, |
| | | | weekly, daily, on week days or not |
| | | | at all. |
| reminder_days | Integer | 1 | Days in advance to send the |
| | | | reminder. |
| event_id | Integer | 4 | Will be zero for a local event. |
| start_time | Date | | Start date/time for the event. |
| duration | Integer | 2 | In minutes. |
| flags | Integer | 2 | Option flags. |
| repeat_interval | Integer | 1 | Not currently used. |
| scheduler | Integer | 4 | Member number of the scheduler. |
| date_posted | Date | | Date/time event was posted. |
| end_repeat | Date | | Last date of repeating event. |
| web_page | Character | 40 | The events description. |
| description | Character | 40 | The events description. |

Table 7 illustrates user data, including a member number assigned to a user, e-mail identification data of the user. This user data is stored on the system. When a user inputs information into the system, in particular, user information, the information input by the user is compared with the system's user information, such as, for example, the user information displayed in Table 7.

TABLE 7
Field Definition For The Member Name Table

| Field Name | Type | Length | Description |
|---|---|---|---|
| member_number | Integer | 4 | The member number. |
| primary | Logical | 1 | Is this the primary email |
| | | | address? |
| email_address | Character | 40 | Will be stored in lower case. |

Table 8 illustrates user data, and in particular access data for permitting a user to access the calendar of another user.

TABLE 8
Field Definition For The Security Table

| Field Name | Type | Length | Description |
|---|---|---|---|
| member_number | Integer | 4 | The member number. |
| access | Integer | 1 | Code to determine the user's |
| | | | access to the schedule. |
| domain_name | Character | 20 | Allows the schedule owner to set |
| | | | access based on a domain name. |

Table 9 illustrates information pertaining to the creation of a user's schedule which indicates the time the last schedule for a user was created. The information enables the user to have a current schedule, when viewing the user's calendar with the system.

TABLE 9
Field Definition For The Creation Of Schedules Table

| Field Name | Type | Length | Description |
|---|---|---|---|
| Remote_host | Character | 15 | The IP Address of the user creating |
| | | | the schedule. |
| time_created | Date | | The date/time of the last schedule |
| | | | created from the IP Address. |

TABLE 10
Field Definition For The User Logins Table

| FIELD NAME | TYPE | LENGTH | DESCRIPTION |
|---|---|---|---|
| Remote_host | Character | 15 | The IP Address of the user |
| | | | creating the schedule. |
| Member_number | Integer | 4 | The member number. |
| Signin_time | date | | Date/time of the last sign-in. |

TABLE 11
Field Definition For The Distribution Lists Table

| Field Name | Type | Length | Description |
|---|---|---|---|
| number | Integer | 4 | The distribution list number within |
| | | | the member's personal directory. |
| description | Character | 20 | A description to help the user |
| | | | recognize each distribution list. |

TABLE 12
Field Definition For The Web Pages Table

| Field Name | Type | Length | Description |
|---|---|---|---|
| Number | Integer | 4 | A unique, randomly-generated |
| | | | number for the web page. The |
| | | | number is used to construct a file- |
| | | | name on the server. |
| member | Integer | 4 | The member who owns and uploaded |
| | | | the web page. |
| uploaded | Date | | Date/time the page was uploaded to |
| | | | server. |
| Last_used | Date | | Date/time the page was last |
| | | | referenced. |
| Times_used | Integer | 4 | Count of times the page was |
| | | | referenced. |
| extension | Character | 4 | Must be ‘TEXT’, ‘HTML’ or ‘JPEG’ |
| | | | to indicate the web page contents and |
| | | | help name the file on the server. |
| description | Character | 20 | A description to help the user |
| | | | recognize each distribution list. |

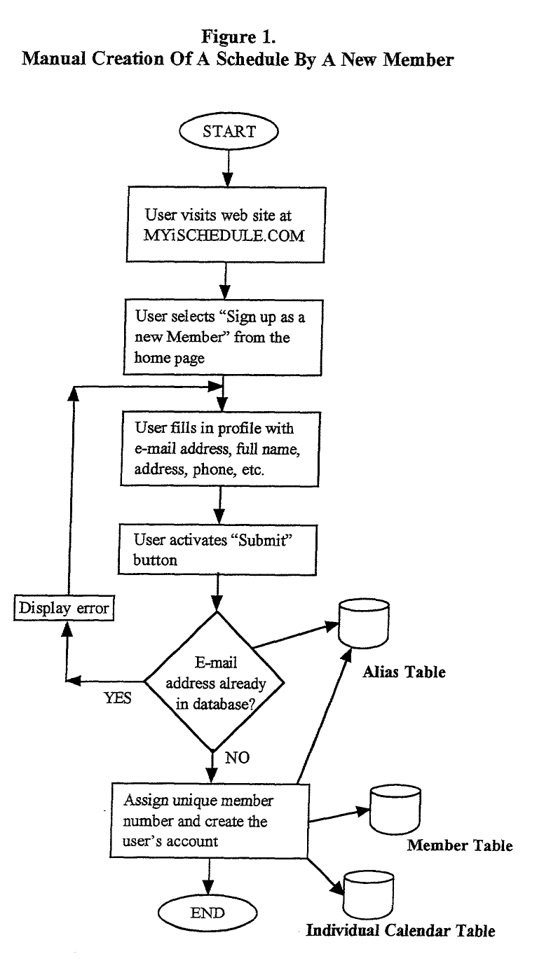

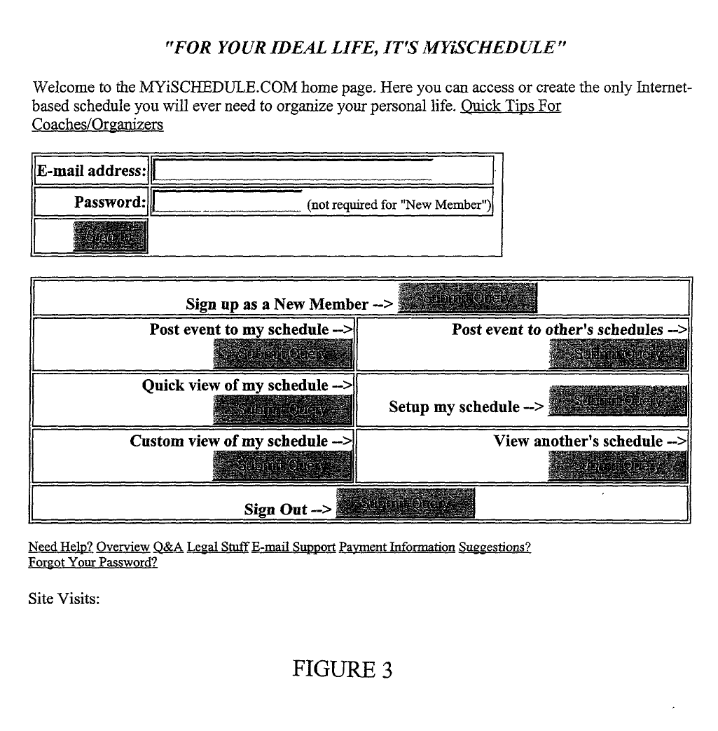

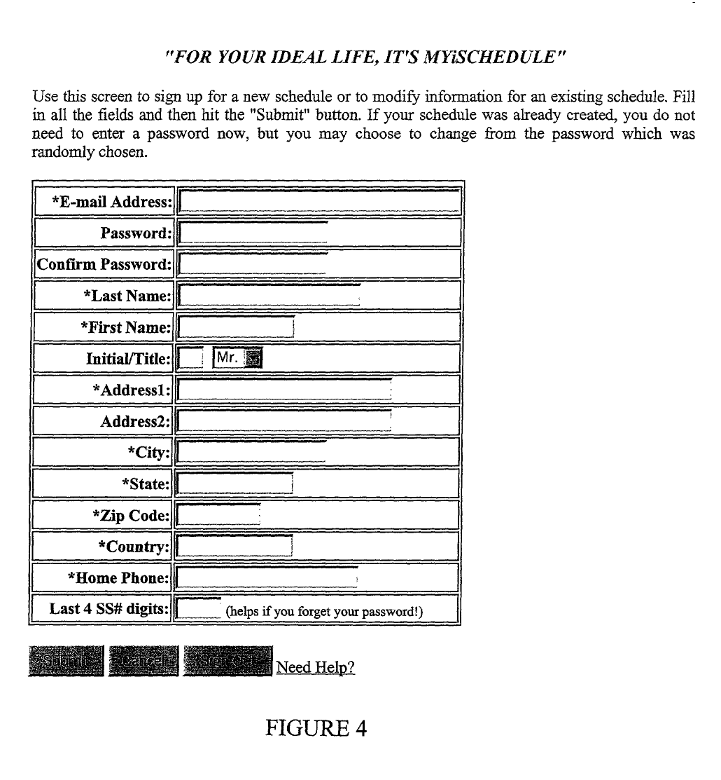

Reference now being made to FIG. 1, there is illustrated a diagram of the system and method for scheduling events on an Internet-based calendar, showing an example of the creation of a new schedule by a new user for that new user. In FIG. 1, a new user desires to sign on to the system as a new member in order to participate in the notification and calendar. When the user becomes a member of the system the user may then display a personal calendar which can be viewed to show to the user events posted for that user. As FIG. 1 illustrates, the user starts by visiting a web site, in this example, the user visits MYiSCHEDULE.COM, and views with viewing means a screen display such as, for example, the display shown in FIG. 3. Once at the web site home page, the user selects “Sign up as a new Member” from the available choices, if other options are also present. The user is then presented with another screen, such as that illustrated in FIG. 4, which prompts the user to enter user information, such as, for example, password information, name and address of the user, and other information concerning the user. The user then submits the information, as illustrated in FIG. 1. The system processor then processes the data entered by the user, and in particular compares the user identification data, preferably, the user email address, with the email address data stored on the system database. The user information which is compared to the email addresses entered by the potential new user includes the primary email address of other users, as well as alias email addresses of other users. FIG. 1 shows that when the user email address is compared, and is determined to match a user email address already in the system data files, the new user information is rejected, and the user is then prompted to submit the information requested in FIG. 4, and preferably is notified that the email address already exists.

FIG. 1 illustrates that when the user enters an email address which is not stored in the system database, then a member identification string, such as, for example, a member number, is created and an account is created for that user. A user sub-file is created for that user, in which may be stored unique information pertaining to that user's selections and preferences. For example, the user's sub-file may contain information as to how the user desires that user's calendar to be displayed.

FIG. 1 illustrates alias means comprising an alias table. Preferably, an alias table stores information regarding the association of users with one or more of the user's respective e-mail addresses. Preferably, the alias table comprises user data and is stored on the system server data base. FIG. 1 illustrates a member table which contains data identifying members of the system. The member table preferably is compared with a user entry when a user logs on to the system to determine whether the user is a member of the system.

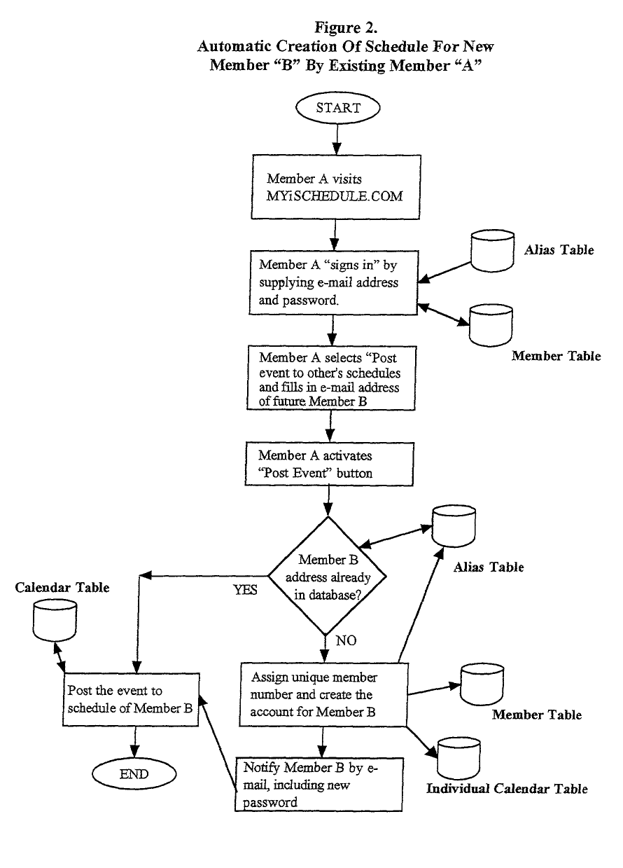

Referring to FIG. 2, there is illustrated a schematic diagram of a system and method for scheduling events on an Internet-based calendar, illustrating an example of the automatic creation of a new schedule by an existing user for a new user. A user beings by visiting the MYiSCHEDULE.COM home page, as described above in connection with FIG. 1. The user logs on to the system by inputting into the system user identification information, preferably, the user's email address and password. This may be done through the user's user device which communicates with the server through a communications link, such as the Internet.

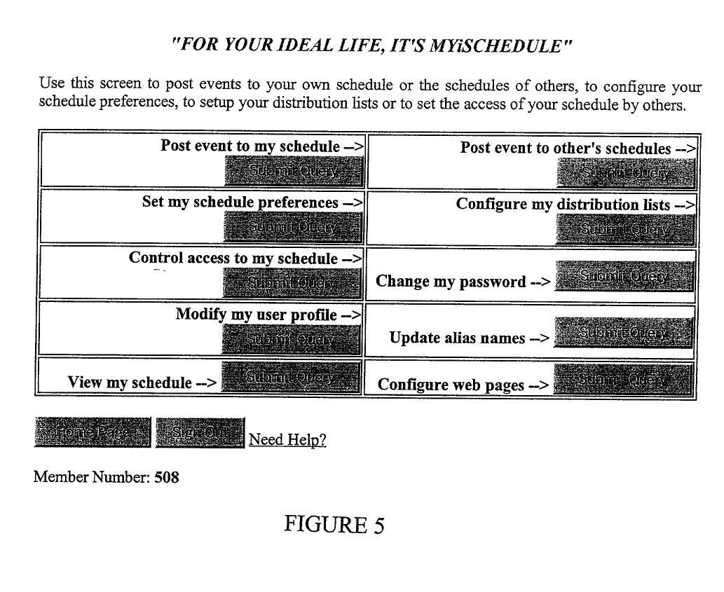

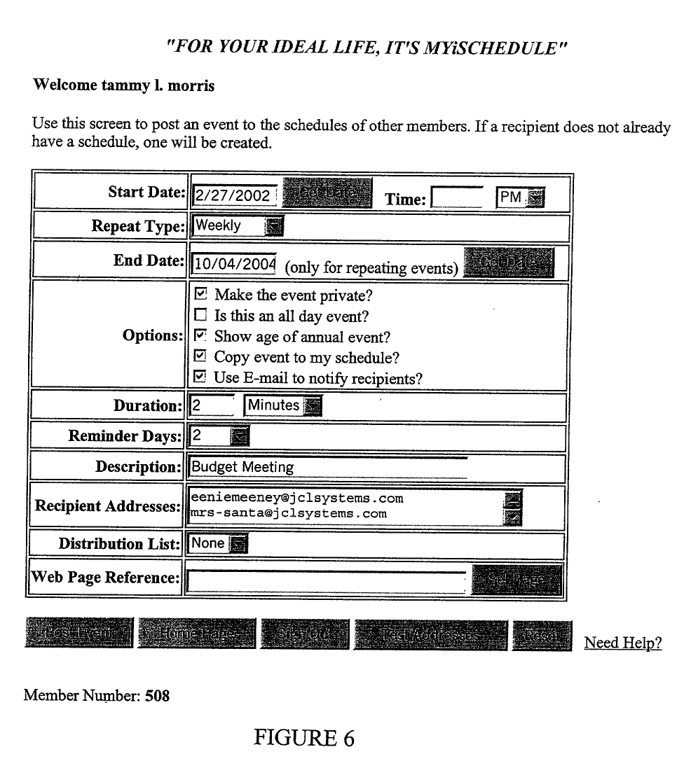

The user identification information entered by the user is compared with the user identification data contained in the alias table and the member table. Upon finding a match of the user identification data, the user is identified as a member of the system and is permitted to proceed further. In the example illustrated in the schematic of FIG. 2, the user, after logging on to the system then proceeds to post an event to other user's schedules. In this example one or more other users are future or potential members of the system. In this illustration, Member A is an established user, and another individual, B, is not yet a user of the scheduling system. Member A, upon logging on to the system, is presented with further options for proceeding, including the option to post an event to other's schedules. Member A may be presented with a screen view on a viewing means, such as, for example, the screen view illustrated in FIG. 5. In this example, Member A selects the option button “post event to other's schedules”. Member A is then presented with a screen, such as, for example, that shown in FIG. 6, where the information about the event can be input by the posting user, here Member A. Once the information about the event is input by Member A, one or more recipients of the event are designated. The user or users who are to receive the notice of the event are designated when Member A inputs the email address of each user who is to receive the notification. In FIG. 2, B is not a registered member of the system. When Member A posts the event to B's calendar, Member A inputs B's email address in the recipient addresses field, as shown on the screen display exemplified in FIG. 6. When Member A posts the event, by selecting the “post event” button shown in FIG. 6, the information is submitted. The email address or addresses entered in the “recipient addresses” field are processed by comparing each of those email addresses with email addresses already stored in the system and associated with a user. In the example represented by the schematic of FIG. 2, there is no match for B's email address. B's email address is compared with the email addresses stored in the Alias table and the member Table which includes a comparison of user identification data of the system to determine whether there is a match.

There being no match, the processing means designates a file for the individual, B, assigning a unique user number and account for B. The processing means then undergoes a further step of notifying B, inviting B to become a user of the system. Preferably, an email message is sent to the email address entered by Member A for B, and the invitation is transmitted to B informing B of the system and potential message which is waiting for B. When B has entered the requested user information, B becomes a member and may begin to use the system, viewing B's calendar with the event posted by A, as well as posting events for users and non-users of the system, and using the features and options available.

A user may post an event to several users of the system. Distribution list means is provided to facilitate the posting of an event to the schedule of one or more users without having to retype each user's email address. The distribution list means preferably comprises a field which is viewable when a user enters event data. As shown in FIG. 6, there is a field “Distribution List” and a drop down box prompted with an arrow for the user to select a distribution list. The distribution list preferably may be created on the user's user device, then transmitted to, and stored on, the system The distribution list can then be identified with a unique name and used by the user who created the distribution list for future posting of events. For example, a team list may be created by a user who is a coach of a sports team who from time to time posts events to the schedules of his team who preferably are also users of the system.

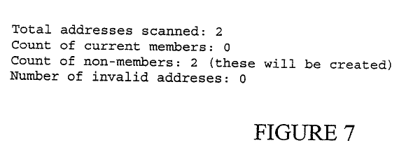

The invention further includes user testing means for enabling a posting user to test the integrity of an email address input as a recipient address when posting an event. The user testing means is activated by the button shown in FIG. 6, “Test Addresses”. The selection of that button by a user obtains a confirmation from the system of whether the email address or addresses entered are recognized by the system as being associated with a user of the system. The processor means compares the recipient address entered by the posting user with the system email data which is part of the user information, and identifies all matches. As shown in FIG. 7, the confirmation of the test may include a display on the user's viewing means of the confirmed email addresses. The failure to confirm an email address indicated to the user that the email address of the intended recipient is not recognized.

The system and method of the invention further permits a user to edit the user's information. For example, a user may change the user's password by signing on to the system and then entering the requested information, such as in the fields illustrated in the screen display shown in FIG. 5.

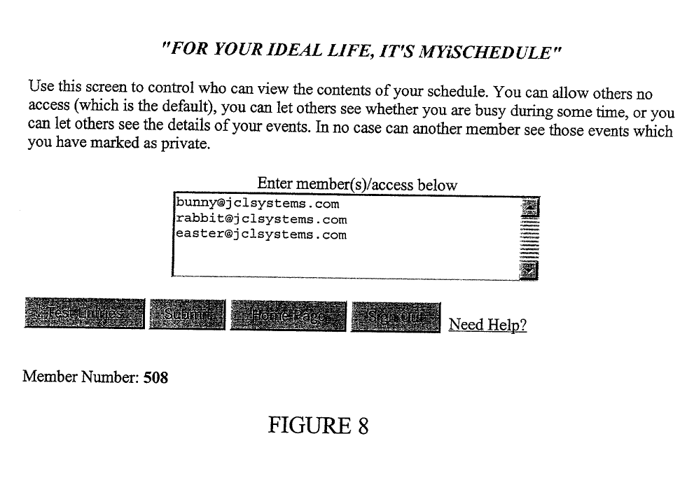

Sharing control means may facilitate sharing of a user's calendar or schedule with one or more other users of the system. Preferably, the user can select which users may see that user's schedule. Illustrating the sharing control means is found in FIG. 8 where a screen display is shown in FIG. 8 with a “test” and “submit” button. As shown in FIG. 5 an option appears with a prompt “Control access to my schedule”, which the user may select to be presented with options for permitting and/or limiting access to that user's schedule, such as the access list shown in FIG. 8 where the user can identify other users who may view that user's schedule. FIG. 6 further illustrates the sharing control means with a screen display showing the information which a user may input to limit or permit access by other users to a posted event on that user's schedule.

In conjunction with the sharing control means, privacy designation means is preferably provided for enabling the user, when posting an event, to specify that an event is to be private. When the user designates an event as a private event, the event data for that event is not shared or viewable by those other users, even if they had been given access to the schedule of the user posting the private event. A privacy field is supplied for a user entering event information, such as, for example, as shown in the screen display illustrated in FIG. 6.

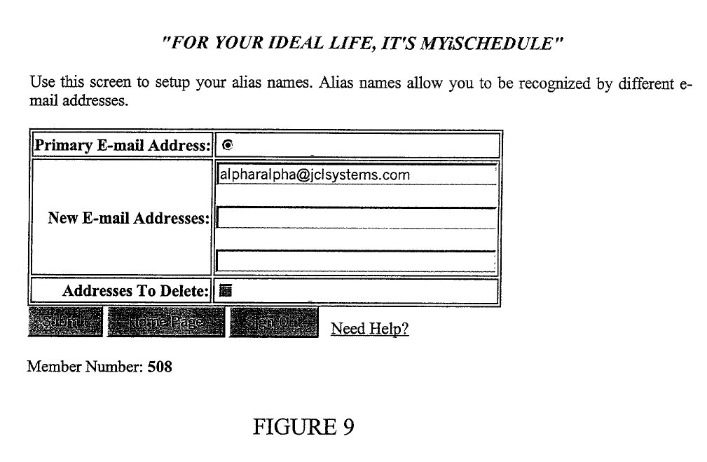

The user may modify user information, as necessary. For example, if a user changes the user's email address, the user may make that change by adding the address to the alias table. Further, the user may modify an existing schedule by deleting or adding events. Referring to FIG. 9, the alias means is illustrated, providing the ability to add additional e-mail addresses for association with a user, as well as the ability to modify by deletion of previously entered e-mail addresses.

FIG. 3 illustrates a printout of a screen display illustrating the method and system of the invention. In FIG. 3, a first screen or home page is shown displaying thereon options which the user can select. The option buttons are shown featuring the following:

Quick view of your schedule

Custom view of your schedule

Create a new schedule

Access your schedule

View another's schedule

Sign out

In order to select any of the option buttons and proceed, a user must identify himself or herself by inputting with input means, preferably by typing, the user's identification data, such as the user's e-mail address, and a password. The user then selects the “Sign In” button and the user is logged onto the server. The user may then select from the options presented, which preferably include those options shown in the screen display illustrated in FIG. 5.

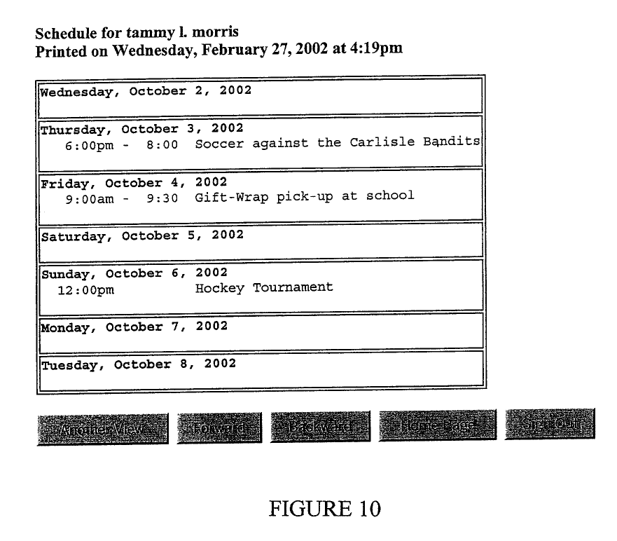

FIG. 10 illustrates a view of a schedule for a user, wherein the user has selected to display a schedule for seven consecutive days. Other views showing scheduled events can be selected, including, for example, a detailed view which lists the event description along with event data such as day of event start time and duration of the event, as well as the person who posted the event, such as, for example a coach or sponsor of the event.

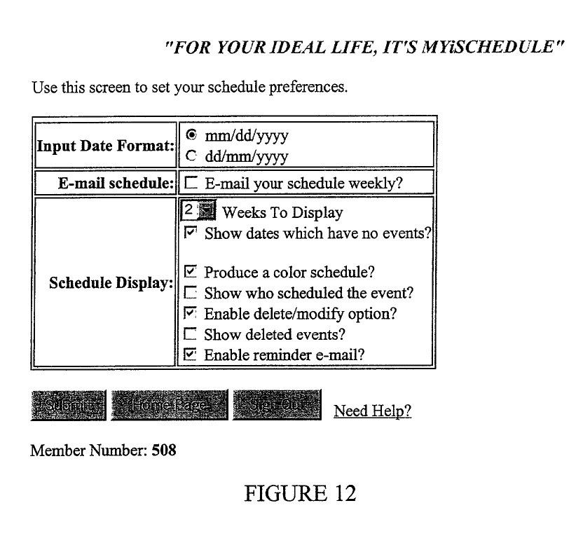

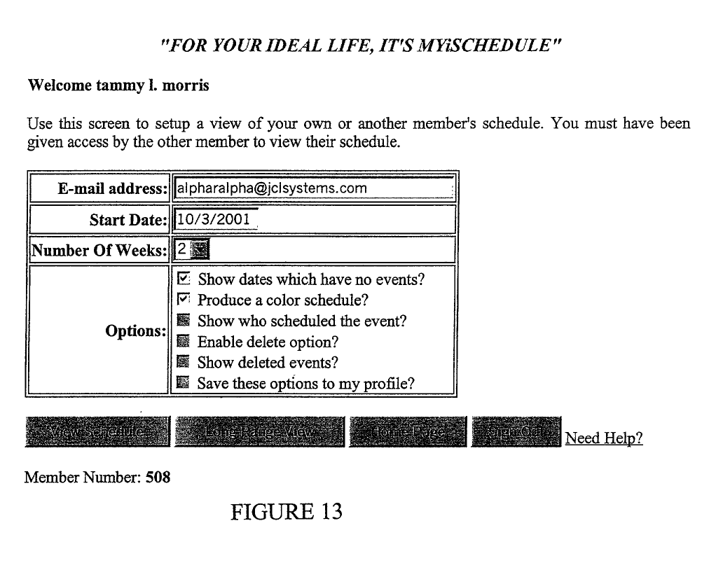

FIG. 12 is an illustration of a screen display showing examples of viewing options or preferences for a user's calendar. Options which the user can select to customize the calendar view, such as the view illustrated in FIG. 10, can include, a start date, a number of weeks, as well as options including whether or not to show dates which have no events, provide the schedule in color, show the identity of the user who scheduled the event, and to save the options for the user's profile. Similarly, in FIG. 13, options for viewing the schedule of another user who has given the accessing user permission is illustrated.

FIG. 5 illustrates a view of a screen presenting additional options to the user of the system. For example, the button shown permits the user to post an event to the user's schedule, or to post an event to other's schedules. Other options appearing on the screen include:

Post event to my schedule

Set my schedule preferences

Control access to my schedule

Modify my user profile

View my schedule

Post event to other's schedules

Configure my distribution lists

Change my password

Update alias names

Configure web pages

Referring now to FIG. 6, there is illustrated a screen which can be accessed by a user of the system to post an event to the schedules of other users. The fields shown are examples of event data which the user inputs into the system. In this example shown in FIG. 6, there is also event data which can be selected to include repeat type data, which can cause a posted event to repeat its occurrence on the calendar for a particular interval, weekly, monthly, annually, etc.

Event data shown in FIG. 6, preferably may include options which characterize the event, by making it private so that only the user may see it, or making the event an all day event, showing the age of an annual event (such as the nth birthday where n is an integer representing a person's age). Another option provides the user with the ability to copy a posted event to the user's own schedule. Other event data which the user may designate includes the duration of the event; reminder notification data which links a reminder notice, such as email notification, with the event; as well as a description of the event; recipient's addresses (e-mail).

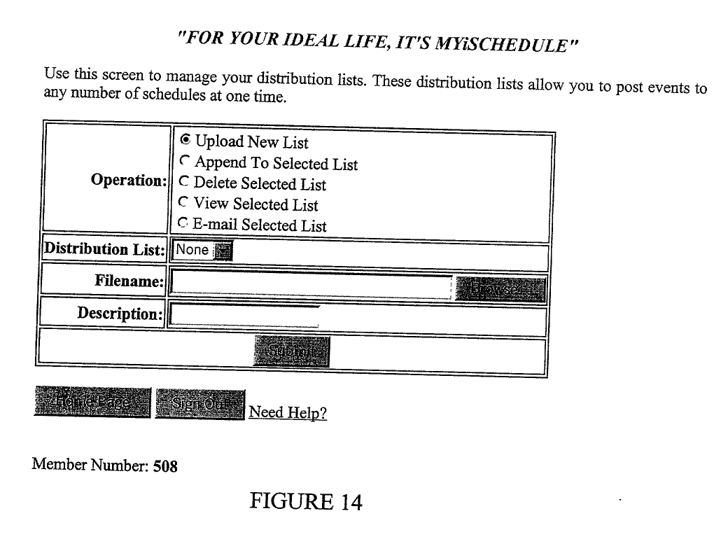

Referring to FIG. 14, the distribution list management screen is illustrated. The method of the present invention provides a user with the ability to post a single message to a number of users of the system, including both registered and non-registered users. A collection of the recipient user's identification, such as e-mail addresses, can be stored in a file on the posting user's personal computer, and then called up as a list by the posting user. This list can be named and saved to become a distribution list of recipients who are to receive a posted message. In this manner, the user can establish one or more, or even several lists for each group of recipients. For example, a soccer coach can establish a distribution list for the soccer team, and another list for a church group, and call the lists up, as needed. The distribution lists can also be maintained by appending a list, deleting a list, or replacing a list. The system and method enable a user to associate a description with the list to distinguish one list from another.

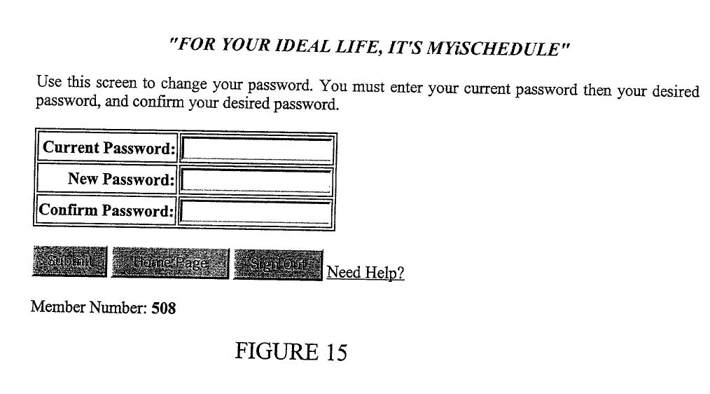

FIG. 15 shows an illustration of a password screen for a user, such as, for example, when the user selects the button to change the password shown in FIG. 6.

FIG. 4 is an illustration of a user sign-up screen. The user sign up screen displays fields for user data, which includes corresponding prompts indicating to the user which data to supply.

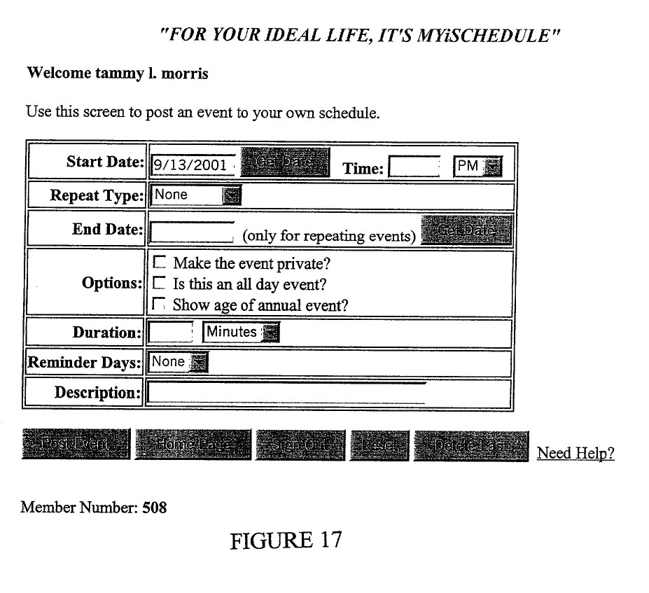

FIG. 17 shows an example of a screen display which contains fields for event data which a user enters for information about an event to be posted to the user's own calendar or schedule. This screen is similar to the screen display shown in FIG. 6 where event data is entered and is posted to calendars of other users, except that the recipient is automatically designated as the user, and there are no other fields to designate other users to receive the event. In addition, the event posted to the user's calendar may be facilitated by the alias means so that regardless of which user associated e-mail address the user signs on with, the event is posted to that user's calendar. Therefore, the event data is not shared by this posting and remains the posting user's own event. However, even though the event is posted only on the user's calendar, if the user has elected to share his calendar with others, the event is also visible to those viewing the user's calendar. The option of making the event private can be selected by the user to make the user-posted event to the user's own calendar inaccessible to other users, even those users who are permitted to otherwise share (i.e., view) the user's calendar.

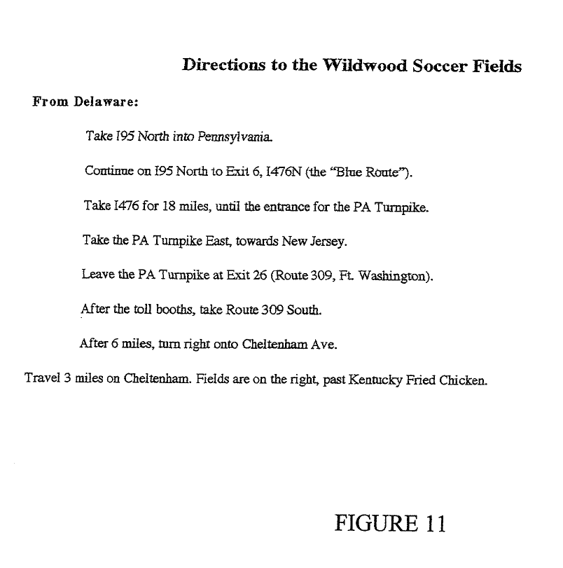

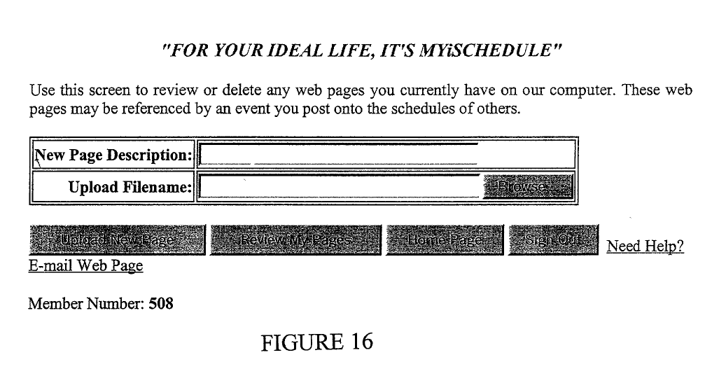

FIG. 16 illustrates an example of a screen display which enables a user to manage information, such as, link data, which the user has placed on the system to be viewed in connection with one or more events which that user has posted. As shown in FIG. 11, the link data may comprise directions pertaining to a scheduled event, such as the soccer game in the example calendar illustrated in FIG. 10. The word “directions” appears in the Wednesday, Oct. 3, 2001 entry on the calendar shown in FIG. 10, and when a user selects the “directions” by clicking with a mouse, the link data associated with the file “directions” is accessed and made available for viewing in the form shown in FIG. 11. Link data can comprise pictures, text, or other material which a user may store on the system for retrieval by other users in association with a posted event.

Optionally, event notification means may be provided where a user who is the intended recipient of a posted event receives notification, even if the user does not access the users calendar. Such event notification means can, for example, comprise an associated e-mail message sent to the intended recipient user notifying that user that there has been a new event posted to that user's calendar. Optionally, or alternately, a telephone message may be transmitted to a user's telephone number to transmit a voice message indicating that there is an event that has been posted on that user's calendar. A user also may have the option to turn off the telephone or e-mail notification, and may select this option when signing up or when modifying that user's information.

### EXAMPLE 1

Example 1 provides a system, which includes the following:

| | |
|---|---|
| The data storage means comprises: | a hard disk drive 30 GB IDE Disk |
| | Drive 7200 RPM |
| The view means comprises a monitor: | a 17″ CRT |
| The input device comprises: | a standard computer keyboard |
| | and mouse |
| The server (central processing unit) | Compaq Alphaserver DS10 |
| | ASVR DS10 67/600 MHz CPU |
| | With 256 MB cache |
| The user device | A personal computer, Compaq |
| | Presario, Pentium III Processor, |
| | 64 MB RAM, Hard Disk Drive |
| Internet linkage though a DSL | |
| connection and using an ISP | |

The system server has a hard disk drive for storage of data, including user data and event data. A first user who, in this example, is a coach of a basketball team, has just received a list of players to be on his team. The players, in this example, are members of a basketball league, and are those members who have been preselected by the coach or the league to comprise the coach's team. As, league members, each player has supplied, with the player's information, an e-mail address for identification of the player. The coach, or first user, must register to become a user of the system. This is done by accessing a web page of the system web site, and entering the requested information when prompted. The coach, once registered, can post events to the calendars of each team member. The coach may first enter the identification of the users who are to receive notification of the event on their calendars. Using the keyboard or mouse, the user's name, in this example the team member, is selected or input into a recipients field. Other users are selected or input in the same manner, until all of the users who are to receive notification of the coach's event have been identified and selected.

The coach may maintain a team distribution list, which can comprise a group of users. The coach can add users to, or delete users from, the distribution list. The distribution list facilitates the identification of recipients of the event notification, since once the coach has established the list, several users can be selected at once.

An event is posted on the system by the coach. The coach has just received the game schedule for the team's season. The coach enters the event data into the system. In this example, the event data comprises the date and time of the game, the location of the game, and the team's opponent. The coach then posts the event data to the system.

The posted event data is stored on the system hard drive, and is also associated with each user selected by the coach to receive the notification of the event. The event data is placed in the user data file, including in the user data sub-file of each user to whom the event was posted and is available for viewing when a user accesses the user's calendar.

In this example, a user who is a member of the basketball team, accesses a personal calendar by logging on to the system with the user's own user device, which preferably comprise a personal computer with a monitor, keyboard and mouse, and has an Internet linkage. The user accesses the system web page, and where prompted, enters the user information data. The entered user information data is processed with a processor, here the CPU of the server computer, and in doing so is compared with the user information data associated with each user of the system. If the user identification data is matched with a user, such as player A here, then player A is permitted to use the system, and is provided with further options. When selecting the display calendar option, player A's personal calendar is displayed on a display, such as a computer monitor. Player A's personal calendar includes the events posted for player A, including, in this example, events posted by the coach.

Player A may be prompted to register and become a user of the system. Each potential user of the system for whom a posting has been made is notified of the new event and new calendar by email. The email, preferably, contains directions for accessing a web site at which the scheduling system may be accessed, as well as providing the user with a unique, randomly generated password.

Player A's user event data is stored on the system in a user data file. Preferably, as in this example, each user to whom the coach has designated as a recipient, including player A, has a user data file in which the event data for that user is stored. Player A's calendar is viewable to player A when player A successfully logs on to the system. Preferably, as in this example, the viewed calendar of player A provides a listing of events in a chronology to facilitate advising the user, here player A, of the sequence of the events scheduled. An example of the type of calendar view which may be provided for viewing on a monitor in this Example is shown in FIG. 10.

Player A, as a user of the system, has options available for managing and maintaining her calendar. For example, Player A wishes to add an event for her school band practice. Player A can post an event to her personal calendar, indicating the event data, such as, in this example, on January 12^{th}, 4:00 p.m., band practice, at the school gym. Player A also sees that the coach of the soccer team has scheduled a practice for the same day and time. Player A knows she will not attend practice, so Player A deletes the coach's scheduled practice event data from her personal calendar. In this example, the event data for the practice schedule, although posted by the coach and sent to all of the members of the team, has been deleted from the user, Player A's user data file.

### EXAMPLE 2

In Example 2, the user of the system is Player A, who has a friend, Player B. Player B is also a member of the basketball team, and a user of the system. Player A, in this example, adds an event to her personal calendar, which is Friend C's birthday party, to take place on January 14^{th} at 7:00 p.m. Friend C is a friend of Player A and Player B. Player A wishes to share this event with Player B. Player A inputs the event data for the Friend C's birthday party and the event data is stored on the system in a sub-file of event data which is the Player A user data file. Player A by designating with the input means, an appropriate response to a prompt, box, or indicia appearing on the monitor showing the event data screen, shares the event with specified users, here, Player B. When Player B signs on to the system, in the manner described, by inputting user information, included among the events on Player B's calendar is Friend C's birthday party.

### EXAMPLE 3

In this example, a golf course is a user. The golf course arranges tee-times for golfers on a particular day, Saturday, in this example. In this example, golfers are members of an organization or club, and are given notice of club events. In addition, the golfers are required to sign up for tee-times when they want to play. In this example, both, organization members and non-members of the club can play golf. The tee-times are input into the system, and a user is designated to receive the event notification, which here, comprises the tee-time and a description of the location and sponsor of the event. The designated user, when accessing his or her personal calendar, receives the notification of the tee-time. In this case, the tee-time is set for 8:00 a.m. on January 14^{th}, and the user for example is Player A's parent, Parent A. Parent A accesses the system by logging on with the user identification information, and when logged on, views his or her personal calendar. Parent A's personal calendar includes the event data information for events which Player A has received in her personal calendar, and further includes events which Parent A has been designated to receive. In this example, Parent A is able to view the schedule of her child, i.e., Player A, in order to be advised of Player A's scheduling needs. The event notification system, in this example, facilitates parental notification of children's events, and preferably is used as a household calendar for the parents to arrange schedules of themselves and their children.

### EXAMPLE 4

In this example, Player B has a sister, Sister A, who attends JCL Middle School, and is a member of the school band. The school is a registered user of the system, and posts events for school organizations. One of the school organizations is the band. The bandleader has just announced that the band has been invited to give a concert on January 20^{th}, at 3:00 p.m., at the Far Away Senior Center. This event is posted to the calendar of band members, one of whom is Sister A. Sister A logs on to her calendar to access the system, and can view event data for events which Sister A has been designated to receive. In this example, Parent A (who is also the parent of sister A) can view all of the events designated for Player A and Sister A, as well as events designated for Parent A. However, Player A and Sister A cannot see the events of Parent A, by the choice of Parent A selecting an option as the primary user. In this example, Player A and Sister A are secondary users, and although they can view, as well as add or remove events from their own personal calendars that they view when logging on as Player A and Sister A, respectively, they are unable to delete events from Parent A's personal calendar.

### EXAMPLE 5

In this example, Friend C's birthday was entered on Player A's calendar in connection with the posting of an event, i.e., Friend C's birthday party. Optionally, in this example, Player A enters Friend C's birthday as an annual event, causing this event, Friend C's birthday, to recur on the same month and day of each year on Player A's personal calendar. Likewise, this feature can be used for weekly, monthly, and annual events, so that a user need only enter the event once, and have it recur on the calendar at each given time interval selected.

### EXAMPLE 6

In this example, Player A is also preparing for pre-college testing, and is taking a test preparatory course. Player A has registered for the course through her school using her home e-mail address, which is different from her school e-mail address. Both the school, and the testing service are registered users of the system. As in Example 1, the event data is posted by the testing service to notify course attendees of the locations, dates and times of the course schedule of classes. The users are designated based on the information provided to the testing service. The testing company designates Player A with her second e-mail address, in this example, the one used by Player A from her home ISP account. Player A's calendar, in Example 1, has been populated with events which were input with Player A being designated with Player A's school e-mail address. In this example, the home email address of Player A is used by the testing service to select Player A as a course attendee who is to receive the event notification data of the course schedule of classes. Player A, has previously input into the system, both, Player A's school e-mail address and Player A's home or other e-mail address. The user identification data for Player A has alias information, which considers the user information data for Player A's school e-mail address and Player A's home e-mail address to be representative of the same individual user, Player A.

The invention is intended to be broadly construed in accordance with the appended claims.

What is claimed is:

1. A system for scheduling events simultaneously onto a plurality of calendars, comprising:
data storage means for storing data;
input means for inputting data into the data storage means;
viewing means for viewing data;
user data identifying each user or potential user of the system;
event data identifying an event;
association means for associating a user with event data;
user data file containing event data.

2. The system of claim 1, comprising means for permitting a user to add and delete events from the user's personal calendar without affecting the events viewable by other users or events on other users' calendars which the deleting user did not post.

3. The system of claim 2, wherein event data comprises one or the other or both of data for a specific event which is stored in the user data file and pointers stored in the user data file pointing to data for a specific event which is stored in a global event file.

4. The system of claim 1, further comprising user group identification means associating one or more users with a group, wherein a user is selected for association as a member of the group by the user creating the group.

5. The system of claim 4, wherein the user selected is the user creating the group.

6. The system of claim 1, further comprising link data for storing retrievable data, and linking means for linking link data with event data.

7. The system of claim 1, wherein user data for each user comprises information for identifying a user.

8. The system of claim 7, wherein the information for identifying a user comprises public/known user information.

9. The system of claim 7, wherein the information for identifying a user comprises a user's email address.

10. The system of claim 1, wherein the user data identifying each user or potential user of the system comprises a user identifying string.

11. The system of claim 10, wherein the user identifying string can be associated with one or more alias strings of the user to associate the user with event data posted for that user under each of the user identifying strings and alias strings, regardless of which user identifying string the user inputs to sign onto the system.

12. The system of claim 1, including control means for controlling the availability of information on a user's calendar for viewing by other users.

13. The system of claim 12, wherein the control means comprises means for selectively permitting a first user to compare a time interval with a scheduled event on a second user's calendar for ascertaining whether the second user has available time or whether an event is scheduled for that time interval.

14. The system of claim 12, wherein the control means comprises means for selectively permitting a first user to view a second user's calendar.

15. The system of claim 12, wherein the control means comprises means for selectively permitting a first user to allow a second user to view one or more events of the first user's calendar.

16. The system of claim 12, wherein the control means comprises means for selectively permitting a first user to prevent other users from viewing one or more events of that first user's calendar.

17. The system of claim 14, wherein the control means comprises means for selectively permitting a first user to prevent other users from viewing one or more events of that first user's calendar.

18. The system of claim 1, further comprising reminder means for generating a reminder of an event which is sent to the user in advance of the event.

19. The system of claim 1, farther comprising means for controlling the reoccurrence of an event at a predetermined interval.

20. The system of claim 19, wherein the recurring event is counted to provide on the user's calendar the recurring event at the predetermined interval with the counted number associated with the event.

22. The system of claim 20, wherein the recurring event is an annually recurring event, and wherein the event data is controlled to list the event annually on the user's calendar.

23. The system of claim 1, further comprising user testing means for enabling a user to determine whether email addresses of intended recipients of a message are users of the system based on one or more associated email addresses associated with the user.

24. A method for providing notification of one or more scheduled events and scheduling events comprising the steps of:
a) providing data storage means for storing data;
b) providing input means for inputting data into data storage means;
c) providing viewing means for viewing data stored in the data storage means;
d) inputting with input means information about an event into data storage means;
e) inputting with input means into the data storage means user data;
f) providing processor means for processing data;
g) associating event data with user data;
h) comparing user data associated with event data with user information data to identify a user;
i) associating an event with an identified user to create a user data file;
j) storing on the data storage means a user data file wherein the user data file contains information pertaining to a user;
k) inputting personal user data information into the user data file;
l) providing a user identification string containing user identification data;
m) establishing a user identification data subset containing a user password data; inputting with input means a user data information and user password data;
n) accessing stored user data;
o) comparing the input user data information and password data with user information data and corresponding user password data stored on the system to identify a user selected to receive event data;
p) storing in the user data file of a user selected to receive event data, event data;
q) displaying on viewing means a calendar graphic which includes the event data of the user data file.

25. The method of claim 24, wherein the method of storing event data in the data storage means comprises the steps of storing event data in at least two files, the at least two files including a global event data file and a user data file, wherein the step of storing event data comprises associating event data stored in a global event data file with event data stored in a user data file.

26. The method of claim 25, further comprising the step of maintaining a user's calendar of events by selectively deleting events from the user's calendar.

27. The method of claim 24, wherein the step of creating user identification data comprises inputting with input means one or more user identification strings which correspond with a single user to represent a single user into the data storage means and associating one or more user identification strings which represent a single user with event data.

28. A method for notifying a person of one or more scheduled events on a calendar, comprising the steps of associating with a person a calendar and notifying the person when there is an event posted to the person's calendar, and providing means for permitting the person to access and view the person's calendar.
